(19) United States
(12) Patent Application Publication
(10) Pub. No.: US 2012/0221693 A1
(43) Pub. Date: Aug. 30, 2012

(54) TEMPORARY RESTRICTIONS AND ROLLBACK

(75) Inventors: Kevin Cutler, Carp (CA); Haiqing Ma, Ottawa (CA); Hamdy Farid, Kanata (CA)

(73) Assignee: ALCATLEL-LUCENT CANADA INC., Ottawa (CA)

(21) Appl. No.: 13/035,406

(22) Filed: Feb. 25, 2011

(51) Int. Cl. G06F 15/173

(52) U.S. Cl. 709/223

(57) ABSTRACT

Various exemplary embodiments relate to a method and related network node including one or more of the following; receiving, at the session management node, an event notification; retrieving an object associated with the event, wherein the object includes an authorized value for a particular attribute; determining, based on the event notification, that the object should be temporarily modified; determining, based on the event notification, an adjusted value for the particular attribute; inserting the adjusted value for the particular attribute into the object without modifying the authorized value for a particular attribute; and reauthorizing at least one session based on the object.

### TECHNICAL FIELD

Various exemplary embodiments disclosed herein relate generally to subscription networks.

### BACKGROUND

As the demand increases for varying types of applications within mobile telecommunications networks, service providers must constantly upgrade their systems in order to reliably provide this expanded functionality. What was once a system designed simply for voice communication has grown into an all-purpose network access point, providing access to a myriad of applications including text messaging, multimedia streaming, and general Internet access. In order to support such applications, providers have built new networks on top of their existing voice networks. As seen in second and third generation networks, voice services must be carried over dedicated voice channels and directed toward a circuit-switched core, while other service communications are transmitted according to the Internet Protocol (IP) and directed toward a different, packet-switched core. This led to unique problems regarding application provision, metering and charging, and quality of experience (QoE) assurance.

In an effort to simplify the dual core approach of the second and third generations, the 3rd Generation Partnership Project (3GPP) has recommended a new network scheme it terms “Long Term Evolution” (LTE). In an LTE network, all communications are carried over an IP channel from user equipment (UE) to an all-IP core called the Evolved Packet Core (EPC). The EPC then provides gateway access to other networks while ensuring an acceptable QoE and charging a subscriber for their particular network activity.

The 3GPP generally describes the components of the EPC and their interactions with each other in a number of technical specifications. Specifically, 3GPP TS 29.212, 3GPP TS 29.213, and 3GPP TS 29.214 describe the Policy and Charging Rules Function (PCRF), Policy and Charging Enforcement Function (PCEF), and Bearer Binding and Event Reporting Function (BBERF) of the EPC. These specifications also mention a Subscriber Profile Repository (SPR) that interacts with the PCEF through an Sp interface. These specifications further provide some guidance as to how these elements interact in order to provide reliable data services and charge subscribers for use thereof.

### SUMMARY

Various embodiments relate to a method for handling an event in a subscriber network performed by a session management node, the method including one or more of the following: receiving, at the session management node, an event notification; retrieving an object associated with the event, wherein the object includes an authorized value for a particular attribute; determining, based on the event notification, that the object should be temporarily modified; determining, based on the event notification, an adjusted value for the particular attribute; inserting the adjusted value for the particular attribute into the object without modifying the authorized value for a particular attribute; and reauthorizing at least one session based on the object.

Various embodiments relate to a system for providing network access in a subscriber network, the system including one or more of the following: an interface that receives an event notification; an object database that stores a plurality of objects, wherein each object includes an authorized value for a particular attribute; an attribute retriever that determines an adjusted value for the particular attribute based on the event notification; and an event handler that: retrieves, from the object database, an object associated with the event notification, inserts the adjusted value into the object associated with the event notification, and reauthorizes at least one session based on the object associated with the event notification.

Various embodiments relate to a machine-readable storage medium encoded with instructions for handling an event in a subscriber network, the instructions to be executed by a session management node, the machine-readable storage medium including one or more of the following: instructions for receiving, at the session management node, an event notification; instructions for retrieving an object associated with the event, wherein the object includes an authorized value for a particular attribute; instructions for determining, based on the event notification, that the object should be temporarily modified; instructions for determining, based on the event notification, an adjusted value for the particular attribute; instructions for inserting the adjusted value for the particular attribute into the object without modifying the authorized value for a particular attribute; and instructions for reauthorizing at least one session based on the object.

### BRIEF DESCRIPTION OF THE DRAWINGS

In order to better understand various exemplary embodiments, reference is made to the accompanying drawings, wherein:

FIG. 1 illustrates an exemplary subscriber network for providing various data services;

FIG. 2 illustrates an exemplary session management node for fulfilling subscriber requests and responding to event notifications;

FIG. 3 illustrates an exemplary data arrangement for storing objects for temporary restrictions;

FIG. 4 illustrates an exemplary rule set for determining a temporary restriction;

FIG. 5 illustrates an exemplary data arrangement for storing policies used in responding to event notifications;

FIG. 6 illustrates an exemplary method for processing a received message;

FIG. 7 illustrates an exemplary method for processing an event notification;

FIG. 8 illustrates an exemplary method for reauthorizing sessions based on an object; and

FIG. 9 illustrates an exemplary method for determining an attribute value for an object.

### DETAILED DESCRIPTION

While the 3GPP describes various events that may be reported to the Policy and Charging Rules Node (PCRN), little guidance is provided on how such events should be handled. For example, the 3GPP describes that the Packet Data Network Gateway (POW) may report to the PCRN that a particular user may be out of prepaid credit by including an Out-Of-Credit value in an Event-Notification Attribute-Value Pair. However, the appropriate response to such an event is left unspecified. Further, the appropriate response to the subsequent addition of prepaid credit is unspecified. Accordingly, there exists a need for a method of responding to various events by a PCRN or other session management node.

It should be noted that, while various examples relate to implementations of Long Term Evolution (LTE), as defined by the Third Generation Partnership Project (3GPP), the devices and methods presented herein may be applicable to other access systems or networks such as, for example, a network access system (NAS). Appropriate modifications will be apparent to those of ordinary skill in the art for implementing these devices and methods in conjunction with alternative access systems and/or networks.

It should also be noted that, while various embodiments described herein refer to a “restriction” in the traditional sense of providing a reduced attribute value, the methods described herein may also be used to temporarily increase an attribute value. Accordingly, as used herein, “restriction” means a change to an attribute value, regardless of whether the change is an increase or a decrease.

Referring now to the drawings, in which like numerals refer to like components or steps, there are disclosed broad aspects of various exemplary embodiments.

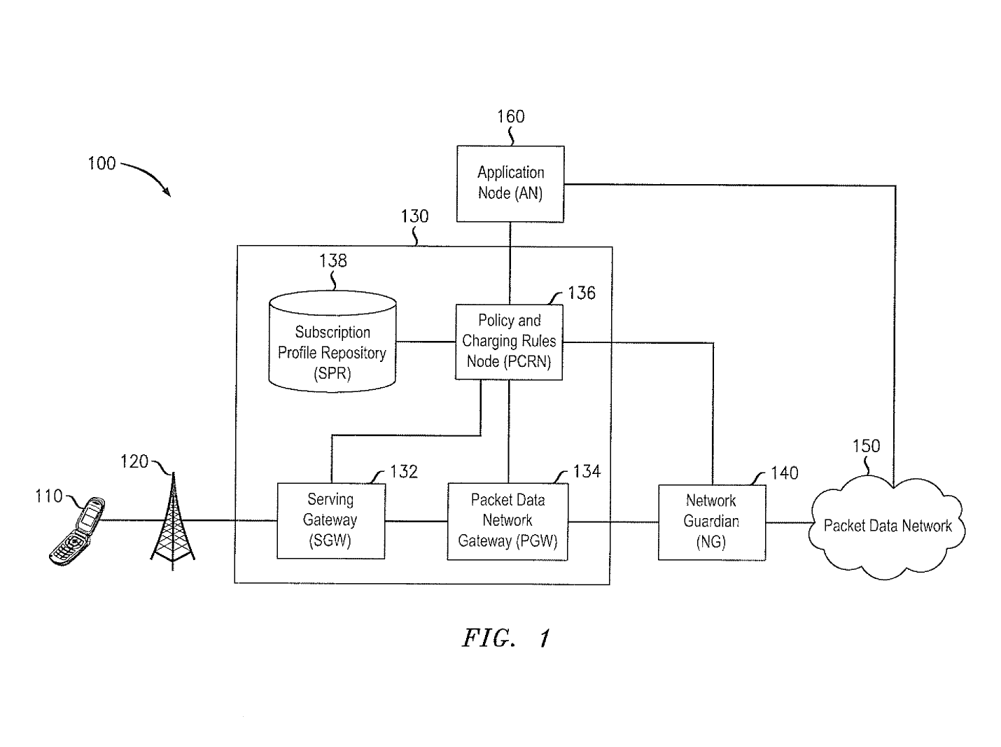

FIG. 1 illustrates an exemplary subscriber network 100 for providing various data services. Exemplary subscriber network 100 may be a telecommunications network or other network for providing access to various services. Exemplary subscriber network 100 may include user equipment (UE) 110, base station 120, evolved packet core (EPC) 130, network guardian (NG) 140, packet data network 150, and application node (AN) 160.

User equipment 110 may be a device that communicates with packet data network 140 for providing the end-user with a data service. Such data service may include, for example, voice communication, text messaging, multimedia streaming, and Internet access. More specifically, in various exemplary embodiments, user equipment 110 is a personal or laptop computer, wireless email device, cell phone, television set-top box, or any other device capable of communicating with other devices via EPC 130.

Base station 120 may be a device that enables communication between user equipment 110 and EPC 130. For example, base station 120 may be a base transceiver station such as an evolved nodeB (eNodeB) as defined by 3GPP standards. Thus, base station 120 may be a device that communicates with user equipment 110 via a first medium, such as radio communication, and communicates with EPC 130 via a second medium, such as Ethernet cable. Base station 120 may be in direct communication with EPC 130 or may communicate via a number of intermediate nodes (not shown). In various embodiments, multiple base stations (not shown) may be present to provide mobility to user equipment 110. Note that in various alternative embodiments, user equipment 110 may communicate directly with evolved packet core. In such embodiments, base station 120 may not be present.

Evolved packet core (EPC) 130 may be a device or network of devices that provides user equipment 110 with gateway access to packet data network 140. EPC 130 may further charge a subscriber for use of provided data services and ensure that particular quality of experience (QoE) standards are met. Thus, EPC 130 may be implemented, at least in part, according to the 3GPP TS 29.212, 29.213, and 29.214 standards. Accordingly, EPC 130 may include a serving gateway (SGW) 132, a packet data network gateway (PGW) 134, a policy and charging rules node (PCRN) 136, and a subscription profile repository (SPR) 138.

Serving gateway (SGW) 132 may be a device that provides gateway access to the EPC 130. SGW 132 may be the first device within the EPC 130 that receives packets sent by user equipment 110 and may forward such packets toward PGW 134. SGW 132 may perform a number of additional functions such as, for example, managing mobility of user equipment 110 between multiple base stations (not shown) and enforcing particular quality of service (QoS) characteristics, such as guaranteed bit rate, for each flow being served. In various implementations, such as those implementing the Proxy Mobile IP (PMIP) standard, SGW 132 may include a Bearer Binding and Event Reporting Function (BBERF). In various exemplary embodiments, EPC 130 may include multiple SGWs (not shown) and each SGW may communicate with multiple base stations (not shown).

Packet data network gateway (PGW) 134 may be a device that provides gateway access to packet data network 140. PGW 134 may be the final device within the EPC 130 that receives packets sent by user equipment 110 toward packet data network 140 via SOW 132. PGW 134 may include a policy and charging enforcement function (PCEF) that enforces policy and charging control (PCC) rules for each service data flow (SDF). Thus, PGW 134 may be a policy and charging enforcement node (PCEN). PGW 134 may include a number of additional features such as, for example, packet filtering, deep packet inspection, and subscriber charging support.

Policy and charging rules node (PCRN) 136 may be a device that receives requests for services, generates PCC rules, and provides PCC rules to the PGW 134 and/or other PCENs (not shown). PCRN 136 may also establish other types of sessions at the request of UE 110 such as, for example, IP Connectivity Access Network (IP-CAN) sessions and/or gateway control sessions. PCRN 136 may receive requests from AN 150 via an RX interface, from SGW 132 via a Gxx interface, and/or from PGW 134 via a Gx interface. Upon receipt of a service request, PCRN 136 may generate or modify at least one PCC rule for fulfilling the service request. PCRN 136 may communicate with SPR 138 via the Sp interface when creating PCC rules. PCRN 136 may, for example, use SPR 138 to obtain subscriber service data and/or to coordinate messages from multiple sources.

Upon creation or modification of a PCC rule or upon request by the PGW 134, PCRN 136 may provide a PCC rule to PGW 134 via the Gx interface. In various embodiments, such as those implementing the PMIP standard for example, PCRN 136 may also generate QoS rules. Upon creation or modification of a QoS rule or upon request by the SGW 132, PCRN 136 may provide a QoS rule to SGW 132 via the Gxx interface.

PCRN 136 may further be adapted to process various event messages. For example, PCRN 136 may receive various event notifications from PGW 134 and/or NG 140. In response to various events, PCRN 136 may temporarily restrict sessions associated with the events. After various subsequent events, PCRN 136 may roll such sessions back to their previous states.

Subscription profile repository (SPR) 138 may be a device that stores information related to subscribers to the subscriber network 100. Thus, SPR 138 may include a machine-readable storage medium such as read-only memory (ROM), random-access memory (RAM), magnetic disk storage media, optical storage media, flash-memory devices, and/or similar storage media. SPR 138 may be a component of PCRN 136, may constitute an independent node within EPC 130, or may be a combination of both. SPR 138 may also be distributed across a network, with some components within EPC 130 and other components connected via a network.

SPR 138 may store a subscription record for a number of subscribers. Each subscription record may include a number of subscription identifiers such as, for example, an IPv4 address, an IPv6 address, an international mobile subscriber identity (IMSI), a network access identifier (NAT), a circuit identifier, a point-to-point protocol (PPP) identifier, and a mobile subscriber ISDN (MSISDN) number. Each subscription record may additionally include subscription parameters such as, for example, bandwidth limits, charging parameters, subscriber priority, and subscriber service preferences.

Network guardian (NG) 140 may be a node adapted to monitor various traffic flows for malicious activity. Accordingly, NG 140 may employ various packet inspection and/or statistical analysis techniques useful in identifying malicious usage patterns between EPC 130 and packet data network 150. It should be apparent that NG 140 may be located elsewhere within exemplary network 100, as long as NG 140 has access to the traffic to be monitored. NG 140 may further communicate with other nodes of exemplary network 100 in order to identify those flows identified as malicious. For example, NG 140 may be adapted to transmit a message to PCRN 136 upend detecting a malicious flow. PCRN 136 may thereafter take remedial action to prevent further malicious activity.

Packet data network 150 may be any network for providing data communications between user equipment 110 and other devices connected to packet data network 150, such as AN 160. Packet data network 150 may further provide, for example, phone and/or Internet service to various user devices in communication with packet data network 150.

Application node (AN) 160 may be a device that includes an application function (AF) and provides an application service to user equipment 110. Thus, AN 160 may be a server or other device that provides, for example, a video streaming or voice communication service to user equipment 110. When AN 160 is to begin providing application service to user equipment 110, AN 160 may generate a request message, such as an AA-Request (AAR) according to the Diameter protocol, to notify the PCRN 136. This request message may include information such as an identification of the subscriber using the application service and an identification of the particular service data flows that must be established in order to provide the requested service. AN 160 may communicate such an application request to the PCRN 136 via the Rx interface.

Various services may be requested, and subsequently established, based on an AAR sent to PCRN 136 by AN 160, based on a CCR sent to the PCRN 136 by PGW 134 or SGW 132, or based on a combination thereof. For example, PCRN 136 may receive an AAR and a CCR both requesting a particular service for a particular user. Accordingly, the PCRN 136 is adapted to determine that two request messages are associated with the same session and process the messages accordingly. For example, the PCRN 136 or a Diameter Proxy Agent (not shown) may use a session binding identifier (SBI) to determine that a request message is related to a previously received request message. Thus, PCRN 136 may establish a session based on an initial request message and subsequently modify the session based on the supplemental request message.

Having described the components of subscriber network 100, a brief summary of the operation of subscriber network 100 will be provided. It should be apparent that the following description is intended to provide an overview of the operation of subscriber network 100 and is therefore a simplification in some respects. The detailed operation of subscriber network 100 will be described in further detail below in connection with FIGS. 2-9.

PCRN 136 may have previously established a service data flow (SDF) for UE 110 by generating and transmitting a policy and charging control (PCC) rule to PGW 134. Presently, PGW 134 may determine that the prepaid account associated with UE 110 has been depleted and, consequently, may transmit an Out-Of-Credit event notification to PCRN 136. In response to the event notification, PCRN 136 may determine that, rather than terminating the SDF, the QoS should be temporarily degraded until additional credit has been purchased. Accordingly, PCRN 136 may generate a modified PCC rule having relatively low QoS characteristics and may install the rule at PGW 134. Thereafter, the service enjoyed by UE 110 may remain uninterrupted but may be degraded.

Subsequently, PGW 134 may determine that the prepaid account has been replenished. Accordingly, PGW 134 may construct another event notification, informing PCRN 136 of this fact. In response, PCRN 136 may “roll back” the temporary restriction by modifying the PCC rule to carry the same QoS characteristics that the rule carried before the temporary restriction. Upon installation of rolled back rule at PGW 134, the service provided to the UE 110 will return to the previously—enjoyed non-degraded quality.

FIG. 2 illustrates an exemplary session management node 200 for fulfilling subscriber requests and responding to event notifications. In various embodiments implementing the LTE standard, session management node 200 may be a PCRN such as PCRN 136. Exemplary session management node 200 may include a Gxx interface 205, a Gx interface 210, an Rx interface 215, a message interpreter 220, a request handler 225, an object database 230, an NG interface 235, an event handler 240, a policy storage 245, an attribute retriever 250, an Sp interface 255, a rules engine 260, and a rules storage 265. It will be apparent that various components may be specific to implementations of particular standards and that various modifications may be appropriate for implementation of alternative standards.

Gxx interface 205 may be an interface comprising hardware and/or executable instructions encoded on a machine-readable storage medium configured to communicate with other network nodes such as, for example, SGW 132 using the Diameter protocol. Accordingly, Gxx interface 205 may be adapted to transmit Reauthorization Request (RAR) and Credit Control Answer (CCA) messages and to receive Reauthorization Answer (RAA) and Credit Control Request (CCR) messages.

Gx interface 210 may be an interface comprising hardware and/or executable instructions encoded on a machine-readable storage medium configured to communicate with other network nodes such as, for example, PGW 134 using the Diameter protocol. Accordingly, Gx interface 210 may be adapted to transmit RAR and CCA messages and to receive RAA and CCR messages.

Rx interface 215 may be an interface comprising hardware and/or executable instructions encoded on a machine-readable storage medium configured to communicate with other network nodes such as, for example, AN 150 using the Diameter protocol. Accordingly, Rx interface 215 may be adapted to transmit RAR and Authorization and Authentication Answer (AAA) messages and to receive RAA and Authorization and Authentication Request (AAR) messages.

Message interpreter 220 may include hardware and/or executable instructions on a machine-readable storage medium configured to receive various messages via the Gxx interface 205, Gx interface 210, and Rx interface 215. Message interpreter 220 may further determine whether a received message includes a request for a new session or an indication of an event. Message interpreter 220 may inspect the AVPs of each received message to make this determination. For example, a CCR that includes a Packet-Filter-Information AVP may indicate a request for a new session while a CCR including an Event-Trigger AVP and/or a network usage report may indicate the occurrence of an event. Message interpreter 220 may forward session requests to request handler 225 and may forward event notifications to event handler 240 for further processing.

Request handler 225 may include hardware and/or executable instructions on a machine-readable storage medium configured to process and fulfill a request message. For example, in response to a request message, request handler 225 may create a new PCC rule, store it in object database, and install it at a PGW via Gx interface 210. Request handler 225 may generate PCC rules based on a subscription profile, a result from rules engine 260, and/or additional objects in object database 230. Request handler may also request a value for particular attributes of a PCC rule from attribute retriever. For example, request handler 225 may request a QoS characteristic, such as a guaranteed bitrate (GBR) or quality of service class identifier (QCI), from attribute retriever 250.

Object database 230 may be any machine-readable medium capable of storing various objects related to session creation and management. Accordingly, object database 230 may include a machine-readable storage medium such as read-only memory (ROM), random-access memory (RAM), magnetic disk storage media, optical storage media, flash-memory devices, and/or similar storage media. Object database 230 may store object representing various entities or characteristics useful in session management. For example, object database may store objects representing PCC rules, aggregate maximum bandwidths (AMBRs), and/or default bearers.

NG interface 235 may be an interface comprising hardware and/or executable instructions encoded on a machine-readable storage medium configured to communicate with other network nodes such as, for example, a network guardian node. NG interface 235 may receive event reporting messages from a network guardian node such as, for example, NG 140, indicating that a particular flow is malicious or exhibiting suspicious behavior.

Event handler 240 may include hardware and/or executable instructions on a machine-readable storage medium configured to receive and process various event messages. Such event messages may be received from message interpreter 220 and/or NG interface 235. Upon receiving an event message, event handler may locate at least one associated object from object database 230. For example, if event handler 240 receives a report via NG-interface 234 that a particular service data flow is exhibiting suspicious behavior, event handler 240 may retrieve the PCC rule object that implements the SDF from object database 230.

Event handler 240 may also determine an appropriate action to take in response to a received event notification with respect to the retrieved object(s). Such response may be hard coded in the event handler 240 or may be defined among various policies stored in policy storage 245. For example, a policy may indicate that, when an OUT-OF-CREDIT condition is reported for a particular UE, the event handler 240 should temporarily restrict an AMBR associated with the UE and the GBR of any PCC rule associated with the UE. Conversely, a different policy may indicate that, upon occurrence of a REALLOCATION_OF_CREDIT event, the AMBR and GBRs associated with the UE should be rolled back. In determining such temporary restrictions, event handler may request values for one or more attributes from attribute retriever 250.

Policy storage 245 may be any machine-readable medium capable of storing various policies for handling events. Accordingly, policy storage 245 may include a machine-readable storage medium such as read-only memory (ROM), random-access memory (RAM), magnetic disk storage media, optical storage media, flash-memory devices, and/or similar storage media. Policy storage 245 may store a number of policies indicating how session management node 200 should respond to various events that may be reported. A number of policies may, alternatively or additionally, indicate a new value for particular attributes. For example, such a policy may indicate a literal value to be used as the temporary attribute value or may indicate that a percentage of the current value should be used as the temporary attribute value. In various embodiments, policy storage 245 may be stored together with object database 230 within memory or may be stored in a separate component. In various alternative embodiments, policy storage 245 may be stored within a different node than session management node 200 and may be remotely accessible.

Attribute retriever 250 may include hardware and/or executable instructions on a machine-readable storage medium configured to receive and fulfill requests for values of particular attributes. For example, attribute retriever 250 may receive requests for guaranteed bitrates, aggregate maximum bitrates, and/or quality of class identifiers. It will be appreciated that the methods herein may be applied to virtually any requested attribute value.

In determining a value for a requested attribute, attribute retriever 250 may rely on a number of different sources. For example, attribute retriever 250 may first attempt to determine if any applicable policy stored in policy storage 245 indicates a new value for the requested attribute. As a further example, attribute retriever 250 may next request a value from the rules engine 260. Attribute retriever 250 may rely on numerous additional resources such as, for example, subscription profile records retrieved via Sp interface 255, system defaults, and/or the requested attribute values indicated in a request message.

Sp interface 255 may be an interface comprising hardware and/or executable instructions encoded on a machine-readable storage medium configured to communicate with other network nodes such as, for example, SPR 138 using the Diameter protocol. Accordingly, Sp interface 255 may be adapted to transmit record queries and to receive subscription profile records in response.

Rules engine 260 may include hardware and/or executable instructions on a machine-readable storage medium configured to receive requests for rule results and apply an appropriate rule based on context data. For example, when determining a temporary value for a particular attribute, attribute retriever 250 may request a rule result from rules engine 260. Using context information provided by attribute retriever 250 or otherwise available to rules engine 260, rules engine 260 may iterate through a number of rules stored in rules storage 265. If the rules engine 260 locates a rule that is applicable to the available context data, rules engine may return the result of the rule (e.g., the appropriate value for the particular attribute) to session manager 225.

Rules storage 265 may be any machine-readable medium capable of storing rules used by rules engine 260. Accordingly, rules storage 265 may include a machine-readable storage medium such as read-only memory (ROM), random-access memory (RAM), magnetic disk storage media, optical storage media, flash-memory devices, and/or similar storage media. In various embodiments, subscription rules storage 265 may be stored together with object database 230 and/or policy storage 245 within memory or may be stored in a separate component. In various alternative embodiments, rules storage 265 may be stored within a different node than session management node 200 and may be remotely accessible by rules engine 260. As yet another alternative, rules engine 260 and rules engine 265 may both be located elsewhere and remotely accessible by session management node 200.

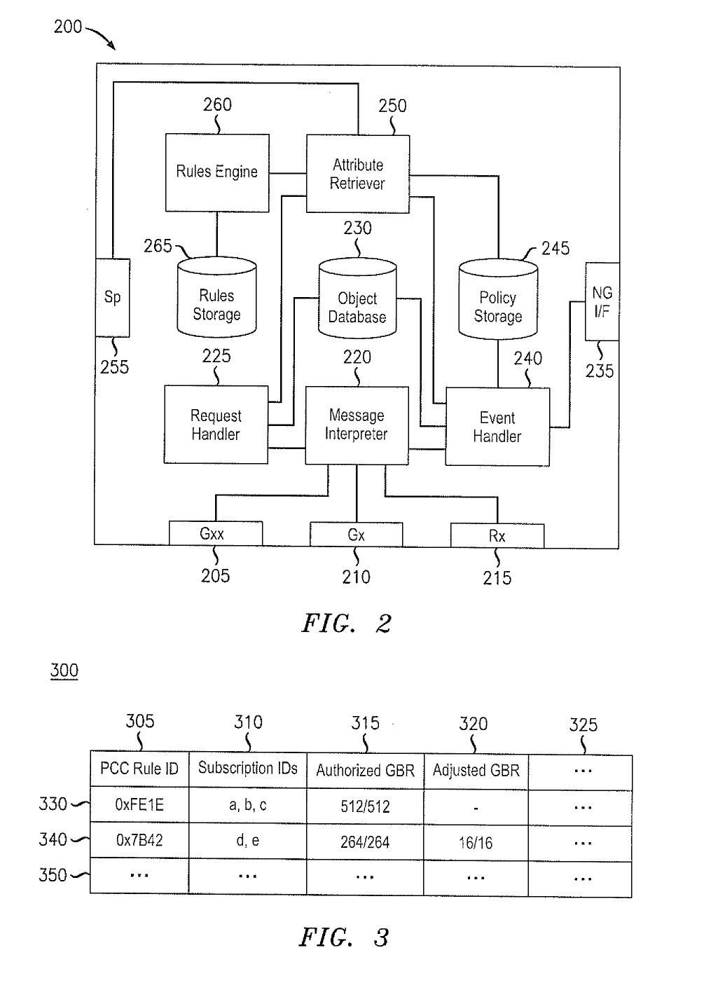

FIG. 3 illustrates an exemplary data arrangement 300 for storing objects for temporary restrictions. Data arrangement 300 may be a table in a database or cache such as object database 230. Alternatively, data arrangement 300 may be a series of linked lists, an array, or a similar data structure. Thus, it should be apparent that data arrangement 300 is an abstraction of the underlying data; any data structure suitable for storage of this data may be used. It should further be apparent that, while data arrangement 300 stores various PCC rule objects, similar data arrangements may be used to store the various other objects of object database 230.

Data arrangement 300 may include numerous fields such as, for example, PCC rule ID field 305, subscription IDs field 310, authorized GBR field 315, and adjusted GBR field 320. Data arrangement 300 may include numerous additional fields 325. It should be apparent that data arrangement 300 is in some respects a simplification. Numerous additional fields 325 may include, for example, a packet filter, subscriber name, and/or maximum bitrates. It should also be appreciated that numerous additional fields 325 may include additional authorized-adjusted field pairs, similar to authorized GBR field 315 and adjusted GBR field 320.

PCC rule ID field 305 may store a unique identifier for a PCC rule. Subscription IDs field 310 may store at least one identifier for a subscription associated with a PCC rule. Accordingly, data stored in subscription IDs field 310 may be used to determine whether an object is associated with a particular event notification. Authorized GBR field 315 may store a guaranteed bitrate for the PCC rule that is to be used when the PCC rule is not restricted. Conversely, adjusted GBR field 320 may store a guaranteed bitrate that is to be used in the PCC rule when the flow is temporarily restricted.

As an example, PCC rule object 330 is associated with PCC rule “0xFE1E.” This PCC rule is provided for the subscriber having subscription identifiers “a,” “b,” and “c.” Further, the authorized GBR for this PCC rule is 512 kbps in both directions. No Adjusted GBR is provided in PCC rule object 330, indicating that the PCC rule is not currently restricted.

As a further example, PCC rule object 340 is associated with PCC rule “0x7B42” and the subscriber having subscription identifiers “d” and “e.” PCC rule object 340 has an authorized GBR of 264 kbps in both directions. PCC rule object 340, however, also includes an adjusted GBR of 16 kbps in both directions, indicating that the associated PCC rule is currently restricted. Data arrangement 300 may include numerous additional objects 350.

FIG. 4 illustrates an exemplary rule set 400 for determining a temporary restriction. Rule set 400 may be a table in a database or cache such as rule storage 265. Alternatively, rule set 400 may be a series of linked lists, an array, or a similar data structure. Thus, it should be apparent that rule set 400 is an abstraction of the underlying data; any data structure suitable for storage of this data may be used.

Rule set 400 may define a rule set useful in determining a GBR for a PCC rule upon occurrence of an OUT_OF_CREDIT condition. Rule storage 265 may store numerous additional rule sets applicable to various other actions, session types, and/or events. Rule set 400 may include a criteria field 405 that defines various conditions to determine whether each rule is applicable to a particular context. Rule set 400 may further include a result field 410 that defines the result that should be returned for each rule, when applicable.

As an example, rule 425 indicates that, upon occurrence of an OUT_OF_CREDIT condition, a subscriber having a subscriber category of “Gold” should be restricted to a GBR of 16 kbps up and 32 kbps down. As a further example, rule 430 indicates that if the subscriber category is instead “Silver,” the GBR should be temporarily restricted to 16 kbps in both directions. As yet another example, rule 435 indicates that if the subscriber category is instead “Bronze,” the GBR should be dropped to zero. Rule set 400 may include numerous additional rules 440.

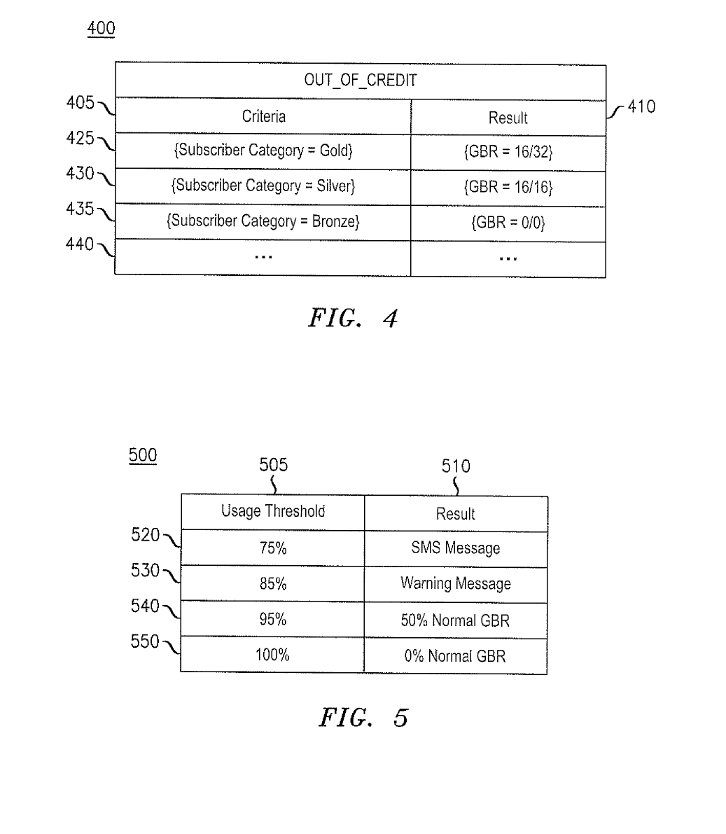

FIG. 5 illustrates an exemplary data arrangement 500 for storing policies used in responding to event notifications. Data arrangement 500 may be a table in a database or cache such as policy storage 245. Alternatively, data arrangement 500 may be a series of linked lists, an array, or a similar data structure. Thus, it should be apparent that data arrangement 500 is an abstraction of the underlying data; any data structure suitable for storage of this data may be used. Data arrangement 500 may indicate various policies applicable to usage reports sent by a POW or similar node. It should be apparent that policy storage may include numerous additional policies applicable to other events and/or notifications.

Usage threshold field 505 may indicate the network utilization that triggers a particular policy while result field 510 may indicate what action should be taken if a particular policy is applicable. For example, policy record 520 indicates that if a particular UE has used 75% of its maximum data allocation, a short message service (SMS) message should be sent to the UE. Similarly, policy record 530 indicates that if the UE has used 85% of its maximum data allocation, a warning message should be sent to the UE. Policy record 540 indicates that if the UE has used 95% of its maximum data allocation, the GBR for the associated PCC rules should be decreased to 50% of the normal value. Finally, policy record 550 indicates that once the UE reaches 100% of its maximum allocated data transfer, the GBR associated with the applicable PCC rules should be decreased to 0.

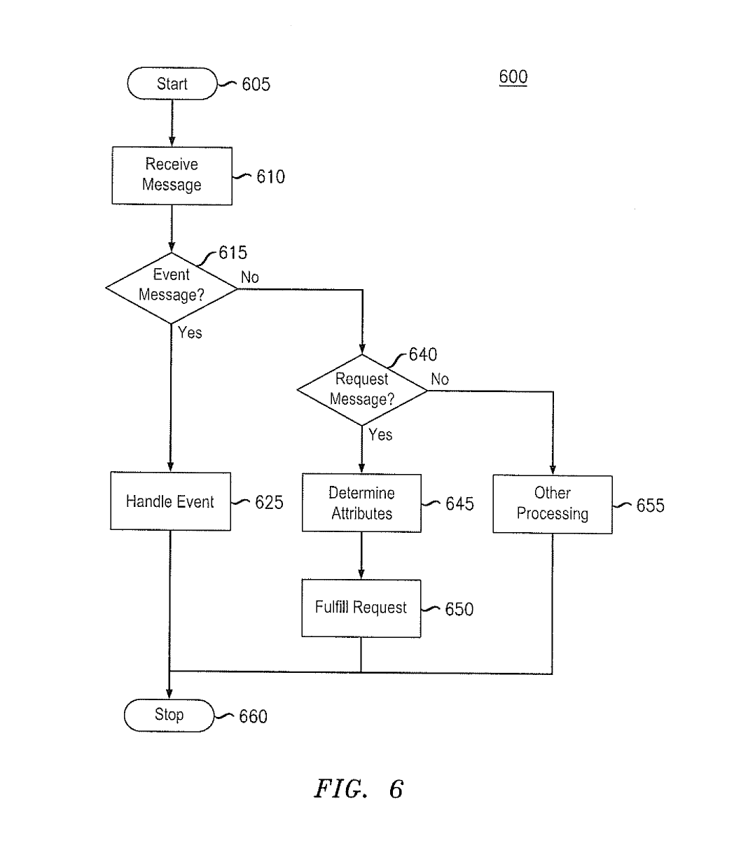

FIG. 6 illustrates an exemplary method 600 for processing a received message. Method 600 may be performed, for example, by the components of session management node 200 such as message interpreter 220, request handler 225, event handler 240, and/or attribute retriever 250.

Method 600 begins in step 605 and proceeds to step 61.0 where session management node 200 receives a message from another network node. Session management node 200 may then determine, in step 615, whether the message is an event notification by, for example, inspecting the contents of the message. If the message is an event notification, session management node may proceed to handle the event in step 625. Method 600 may then end in step 660.

If, however, the message is not an event notification, session management node 200 may instead proceed from step 615 to step 640. In step 640, session management node may determine whether the message is a request for a new session. If so, session management node 200 may determine any attribute values necessary for session establishment in step 645. Session management node 200 may then fulfill the request in step 650 by, for example, creating at least one PCC rule object including the determined attribute values, creating at least one PCC rule based on the available objects, and installing the new PCC rules at a PGW or similar node. Method 600 may then end in step 660.

If, on the other hand, it is determined at step 640, that the message is not a request for a new session, session management node 200 may perform any other necessary or useful processing in step 655 as is known in the art. Method 600 may then end in step 660.

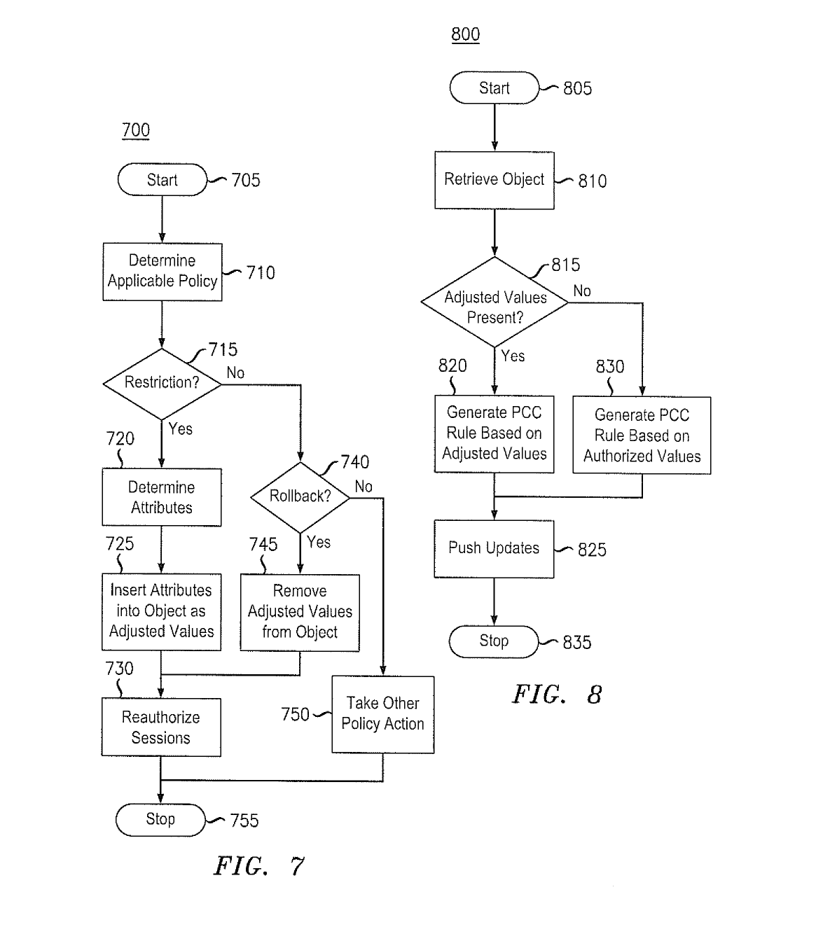

FIG. 7 illustrates an exemplary method 700 for processing an event notification. Method 700 may be performed, for example, by the components of session management node 200 such as event handler 240 and/or attribute retriever 250. Method 700 may correspond to step 625 of method 600.

Method 700 may begin in step 705 and proceed to step 710 where session management node may locate a policy applicable to the received event notification. In various alternative embodiments, session management node 200 may apply other methods to determining appropriate action to take in response to a received event message such as, for example, following hard-coded instructions. Regardless of the method used, session management node 200 determines in step 710 what action is to be taken in response to the received event notification. Session management node 200 may then determine in step 715 whether such action constitutes a restriction to one or more objects. If so, method 700 may proceed to step 720.

In step 720, session management node may determine restricted values for one or more attributes of the associated objects. Subsequently, session management node 200 may insert such attribute values into the associated objects in step 725. Such modification to the objects in step 725 may occur without altering the previous values of the objects. As such, when the temporary restrictions are removed in the future, the previous values may be immediately available for reinstatement. Session management node 200 may then reauthorize any sessions associated with the affected objects in step 730 to implement the restrictions. Method 700 may then end in step 755.

If, on the other hand, session management node 200 determines in step 715 that the appropriate action is not a restriction, method 700 may instead proceed to step 740. In step 740, session management node 200 may determine whether the appropriate action is to roll back any objects that have been previously restricted. If so, session management node 200 may remove the adjusted values from the appropriate objects in step 745 and reauthorize the associated sessions in step 730 to implement the changes. Method 700 may then end in step 755.

If it is determined in step 740 that the appropriate action is not a roll back, session management node may proceed to take other appropriate action in step 750. For example, session management node may send an SMS or warning message to the UE or may terminate a session entirely. Method 700 may then end in step 755.

FIG. 8 illustrates an exemplary method 800 for reauthorizing sessions based on an object. Method 800 may be performed, for example, by the components of session management node 200 such as request handler 225 and/or event handler 240. Method 600 may correspond to step 730 of method 700.

Method 600 may begin in step 805 and proceed to step 801 where session management node 200 may retrieve any objects associated with a session to be reauthorized. In step 815, session management node may determine whether any adjusted values are provided in the object. If so, session management node 200 may generate updated PCC rules based on the adjusted values in step 820. Otherwise, session management node 200 may generate updated PCC rules based on the authorized values in step 830. It should be noted that, in various embodiments, adjusted values may be present for some attributes but not others. In such embodiments, adjusted values will be used whenever present. Various appropriate modifications to method 800 will be apparent to those of skill in the art.

Once the updated PCC rule(s) are created, either in step 820 or 830, session management node 200 may push the updated PCC rules to a PGW or similar node in step 825, thereby installing the new PCC rules and effecting any attribute restrictions or rollbacks. Method 800 may then end in step 835.

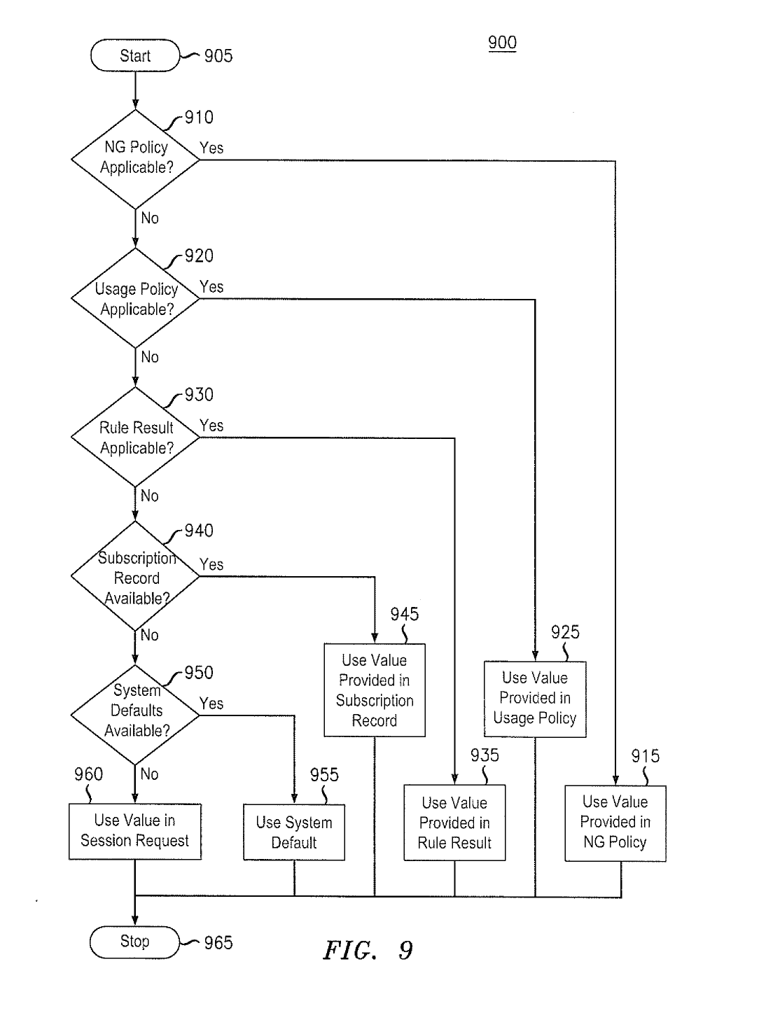

FIG. 9 illustrates an exemplary method 900 for determining an attribute value for an object. Method 900 may be performed, for example, by the components of session management node 200 such as attribute retriever 250 and/or rules engine 260. Method 900 may correspond to step 645 of method 600 and/or step 720 of method 700.

Method 900 may begin in step 905 and proceed to step 910. In step 910, session management node may determine whether any NG policy is applicable to the current context. For example, an NG policy may be applicable if an NG event message was received from an NG node. If so, session management node 200 may determine in step 915 that any attribute value provided in the applicable NG policy should be used. Otherwise, method 900 may proceed to step 920.

In step 920, session management node may determine whether any usage policy is applicable to the current context. For example, usage policy may be applicable if usage report event message was received from another node such as a PGW. If so, session management node 200 may determine in step 925 that any attribute value provided in the applicable usage policy should be used. Otherwise, method 900 may proceed to step 930.

In step 930, session management node may determine whether any rule result is applicable to the current context. For example, a rule result may be applicable if an Event-Trigger AVP was received from another node such as a PGW. If so, session management node 200 may determine in step 935 that any attribute value provided in the rule result should be used. Otherwise, method 900 may proceed to step 940.

In step 940, session management node may determine whether a subscription profile record that contains a value for the requested attribute is available. If so, session management node 200 may determine in step 945 that any attribute value provided in the subscription profile record should be used. Otherwise, method 900 may proceed to step 950.

In step 950, session management node may determine whether any system defaults are available for the requested attribute. If so, session management node 200 may determine in step 955 that the system default should be used as the attribute value. Otherwise, session management node 200 may use whatever attribute value was requested in the initial request message for the session. Once session management node 200 has determined a value for the requested attribute, method 900 may end in step 965.

It should be noted that in various alternative embodiments, the steps of method 900 may occur in a different order and/or may be user configurable. Accordingly, in various embodiments, the relative priorities of particular sources of attribute values may be different. Further, in various alternative embodiments, virtually any context information may be used to determine which source of attribute values is to be used.

According to the foregoing, various exemplary embodiments provide for temporary restriction and rollback of session attributes in a subscriber network. In particular, by adding adjusted values to various objects related to sessions, session attributes may be temporarily adjusted in response to various network events and conditions. Further, by retaining authorized values for the same attributes in such objects, the same sessions may be easily rolled back to their previous states in response to other network events and conditions.

It should be apparent from the foregoing description that various exemplary embodiments of the invention may be implemented in hardware and/or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be effected while remaining within the spirit and scope of the invention. Accordingly, the foregoing disclosure, description, and figures are for illustrative purposes only and do not in any way limit the invention, which is defined only by the claims.

What is claimed is:

1. A method for handling an event in a subscriber network performed by a session management node, the method comprising:
receiving, at the session management node, an event notification;
retrieving an object associated with the event, wherein the object includes an authorized value for a particular attribute;
determining, based on the event notification, that the object should be temporarily modified;
determining, based on the event notification, an adjusted value for the particular attribute;
inserting the adjusted value for the particular attribute into the object without modifying the authorized value for a particular attribute; and
reauthorizing at least one session based on the object.

2. The method of claim 1, further comprising:
receiving a subsequent event notification;
determining, based on the event notification, that the object should no longer be temporarily modified;
removing the adjusted value for the particular attribute from the object; and
reauthorizing at least one session based on the object.

3. The method of claim 1, wherein the event notification is received by the session management node from a network guardian node.

4. The method of claim 1, wherein the event notification indicates that a user device is out of credit for use of the subscriber network.

5. The method of claim 1, wherein the event notification indicates a current network usage of a user device.

6. The method of claim 5, further comprising:
comparing the current network usage to at least one threshold level;
identifying an applicable threshold level;
performing at least one action associated with the applicable threshold level.

7. The method of claim 1, wherein the object represents at least one of a policy charging and control rule, a default bearer, and an aggregate maximum bitrate.

8. A system for providing network access in a subscriber network, the system comprising:
an interface that receives an event notification;
an object database that stores a plurality of objects, wherein each object includes an authorized value for a particular attribute;
an attribute retriever that determines an adjusted value for the particular attribute based on the event notification; and
an event handler that:
retrieves, from the object database, an object associated with the event notification,
inserts the adjusted value into the object associated with the event notification, and
reauthorizes at least one session based on the object associated with the event notification.

9. The system of claim 8, wherein:
the interface further receives a subsequent event notification; and
the event handler further:
determines, based on the event notification, that the object should be rolled back;
removes the adjusted value for the particular attribute from the object, and
reauthorizes at least one session based on the object associated with the event notification.

10. The system of claim 8, wherein the event notification is at least one of a network guardian event, an out of credit event, and a network usage report.

11. The system of claim 8, further comprising a policy storage that stores a plurality of network usage thresholds, wherein the event handler further:
locates an applicable threshold of the plurality of network usage thresholds based on the event notification; and
performs at least one action associated with the applicable threshold.

12. The system of claim 1, further comprising:
a rules storage that stores a plurality of rules; and
a rules engine that:
locates at least one applicable rule of the plurality of rules based on context data, and
returns, as a rule result, at least one value for the particular attribute;
wherein, in determining the adjusted value for the particular attribute, the attribute retriever requests a rule result from the rules engine.

13. The system of claim 8, further comprising a policy storage that stores a plurality of policy records, wherein each policy record indicates a value for the particular attribute and is applicable to a particular event notification, wherein, in determining the adjusted value for the particular attribute, the attribute retriever identifies an applicable policy record based on the event notification.

14. A machine-readable storage medium encoded with instructions for handling an event in a subscriber network, the instructions to be executed by a session management node, the machine-readable storage medium comprising:
instructions for receiving, at the session management node, an event notification;
instructions for retrieving an object associated with the event, wherein the object includes an authorized value for a particular attribute;.
instructions for determining, based on the event notification, that the object should be temporarily modified;
instructions for determining, based on the event notification, an adjusted value for the particular attribute;
instructions for inserting the adjusted value for the particular attribute into the object without modifying the authorized value for a particular attribute; and
instructions for reauthorizing at least one session based on the object.

15. The machine-readable storage medium of claim 14, further comprising:
instructions for receiving a subsequent event notification;
instructions for determining, based on the event notification, that the object should no longer be temporarily modified;
instructions for removing the adjusted value for the particular attribute from the object; and
instructions for reauthorizing at least one session based on the object.

16. The machine-readable storage medium of claim 14, wherein the event notification is received by the session management node from a network guardian node.

17. The machine-readable storage medium of claim 14, wherein the event notification indicates that a user device is out of credit for use of the subscriber network.

18. The machine-readable storage medium of claim 14, wherein the event notification indicates a current network usage of a user device.

19. The machine-readable storage medium of claim 18, further comprising:
instructions for comparing the current network usage to at least one threshold level;
instructions for identifying an applicable threshold level;
instructions for performing at least one action associated with the applicable threshold level.

20. The machine-readable storage medium of claim 14, wherein the object represents at least one of a policy charging and control rule, a default bearer, and an aggregate maximum bitrate.
